(19) United States
(12) Patent Application Publication
(10) Pub. No.: US 2022/0194141 A1
(43) Pub. Date: Jun. 23, 2022

(54) PNEUMATIC TIRE

(71) Applicant: Toyo Tire Corporation, Itami-shi, (JP)

(72) Inventor: Masaru Tada, Itami-shi (JP)

(73) Assignee: Toyo Tire Corporation, Itami-shi (JP)

(21) Appl. No.: 17/548,720

(22) Filed: Dec. 13, 2021

(30) Foreign Application Priority Data
Dec. 21, 2020 (JP) 2020-211125

(51) Int. Cl. B60C 11/12; B60C 11/03

(52) U.S. Cl. CPC B60C 11/1204; B60C 11/0306; B60C 2011/1227; B60C 2011/1213; B60C 2011/0341; B60C 11/1236

(57) ABSTRACT

In a pneumatic tire, a plurality of main grooves include a shoulder main groove which is arranged between a shoulder land and a first middle land, the first middle land comprises a plurality of first middle sipes which are contiguous with the shoulder main groove, the shoulder main groove comprises a plurality of first openings which are contiguous with the plurality of shoulder slits, a plurality of second openings which are contiguous with the plurality of first middle slits, and a plurality of third openings which are contiguous with the plurality of first middle sipes, and the plurality of first openings are respectively separated in the tire circumferential direction from all of the second openings and all of the third openings.

### CROSS REFERENCE TO RELATED APPLICATIONS

This application claims the benefit of priority of Japanese application no. 2020-211125, filed on Dec. 21, 2020, which is incorporated herein by reference.

### BACKGROUND OF THE INVENTION

### Field of the Invention

The present disclosure relates to a pneumatic tire.

### Description of the Related Art

Conventionally a pneumatic tire might, for example, comprise a plurality of main grooves extending in the tire circumferential direction, and a plurality of lands which are partitioned by the plurality of main grooves and a pair of contact patch ends (e.g., JP 2010-274846 A). In addition, a land might comprise a plurality of sipes, the sipes all being respectively contiguous with both ends in the tire axial direction of the land.

As a result, because the sipes will tend to deform so as to become wider, this will make it possible to achieve increase in traction attributable to edges of sipes when on a snowy road surface. It will therefore be possible to improve performance on snowy road surfaces. However, because the fact that the sipes tend to deform means that there is reduced rigidity at the land, there will be a tendency for uneven wear to occur at the land.

### SUMMARY OF THE INVENTION

It is therefore an object of the present disclosure to provide a pneumatic tire permitting improvement in performance with respect to resistance to uneven wear while ensuring good performance on snowy road surfaces.

There is provided a pneumatic tire comprises a plurality of main grooves extending in a tire circumferential direction, and a plurality of lands which are partitioned by the plurality of main grooves and first and second contact patch ends, wherein:

the plurality of lands include a shoulder land which is arranged so as to be outwardmost in a tire axial direction, and a first middle land which is adjacent to the shoulder land;

the shoulder land comprises a plurality of shoulder slits which each extend across a full width of the shoulder land in the tire axial direction, and a plurality of shoulder blocks which are partitioned by the plurality of shoulder slits;

the first middle land comprises a plurality of first middle slits which each extend across a full width of the first middle land in the tire axial direction, and a plurality of first middle blocks which are partitioned by the plurality of first middle slits;

a number of the shoulder blocks is equal to a number of the first middle blocks;

the plurality of main grooves include a shoulder main groove which is arranged between the shoulder land and the first middle land;

the first middle land comprises a plurality of first middle sipes which are contiguous with the shoulder main groove;

the shoulder main groove comprises a plurality of first openings which are contiguous with the plurality of shoulder slits, a plurality of second openings which are contiguous with the plurality of first middle slits, and a plurality of third openings which are contiguous with the plurality of first middle sipes; and

the plurality of first openings are respectively separated in the tire circumferential direction from all of the second openings and all of the third openings.

### BRIEF DESCRIPTION OF DRAWINGS

FIG. 1 is a drawing for explaining a first inclined direction.

FIG. 2 is a drawing for explaining a second inclined direction.

FIG. 3 is a view of a section, taken along a tire meridional plane, of the principal components in a pneumatic tire associated with an embodiment.

FIG. 4 is a drawing showing the principal components at the tread surface of a pneumatic tire associated with same embodiment as they would exist if unwrapped so as to lie in a single plane.

FIG. 5 is a drawing showing the principal components of a center land associated with same embodiment as they would exist if unwrapped so as to lie in a single plane.

FIG. 6 is a drawing showing the principal components of a first shoulder land associated with same embodiment as they would exist if unwrapped so as to lie in a single plane.

FIG. 7 is a drawing showing the principal components of a first mediate land associated with same embodiment as they would exist if unwrapped so as to lie in a single plane.

FIG. 8 is an enlarged view of region VIII in FIG. 4.

FIG. 9 is an enlarged view of region IX in FIG. 4.

### DETAILED DESCRIPTION OF THE INVENTION

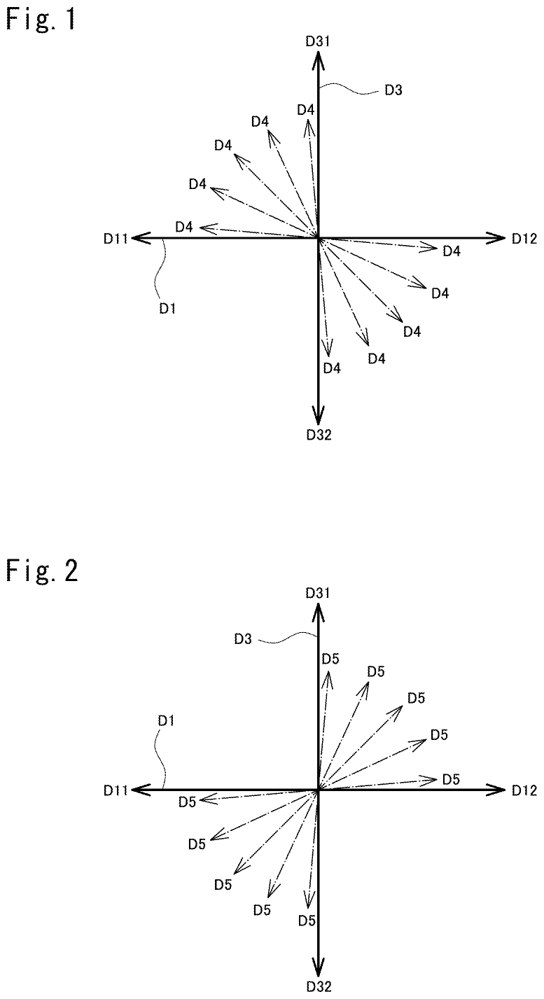

Below, an embodiment of a pneumatic tire is described with reference to FIG. 1 through FIG. 9. At the respective drawings, note that dimensional ratios at the drawings and actual dimensional ratios are not necessarily consistent, and note further that dimensional ratios are not necessarily consistent from drawing to drawing.

Note that the respective dimensions, positional relationships, relative magnitudes, and so forth that are indicated below should be understood to be as measured under normal conditions when the pneumatic tire (hereinafter also referred to as simply “tire”) 1 mounted on a normal rim 30 and inflated to normal internal pressure is under no load. A normal rim is that particular rim which is specified for use with a particular tire 1 in the context of the body of standards that contains the standard that applies to the tire 1 in question, this being referred to, for example, as a standard rim in the case of JATMA, or a measuring rim in the cases of TRA and ETRTO.

Furthermore, normal internal pressure is that air pressure which is specified for use with a particular tire 1 in the context of the body of standards that contains the standard that applies to the tire 1 in question, this being “maximum air pressure” in the case of JATMA, the maximum value listed at the table entitled “Tire Load Limits at Various Cold Inflation Pressures” in the case of IRA, or “inflation pressure” in the case of ETRTO.

At the respective drawings, first direction D1 is the tire axial direction D1 which is parallel to the tire rotational axis that is the center of rotation of tire 1, second direction D2 is the tire radial direction D2 which is the direction of the diameter of tire 1, and third direction D3 is the tire circumferential direction D3 which is circumferential with respect to the rotational axis of the tire.

Toward the interior in the tire axial direction D1 means nearer to tire equatorial plane S1, and toward the exterior in the tire axial direction D1 means farther away from tire equatorial plane S1. Furthermore, the side toward the interior in the tire radial direction D2 is the side which is nearer to the tire rotational axis, and the side toward the exterior in the tire radial direction D2 is the side which is farther away from the tire rotational axis.

First direction D11 of tire axial direction D1 is also referred to as first axial direction D11; second direction D12 of tire axial direction D1 is also referred to as second axial direction D12. Furthermore, first direction D31 of tire circumferential direction D3 is also referred to as first circumferential direction D31; second direction D32 of tire circumferential direction D3 is also referred to as second circumferential direction D32.

Tire equatorial plane S1 refers to a plane that is located centrally in the tire axial direction D1 of tire 1 and that is perpendicular to the rotational axis of the tire; tire meridional planes refer to planes that are perpendicular to tire equatorial plane S1 and that contain the rotational axis of the tire. Furthermore, the tire equator is the line formed by the intersection of tire equatorial plane S1 and the outer surface (tread surface 2a, described below) in the tire radial direction D2 of tire 1.

Note, as shown in FIG. 1, that the direction D4 which is inclined so as to be increasingly directed toward first circumferential direction D31 as one proceeds toward first axial direction D11 (the direction which is inclined so as to be increasingly directed toward second circumferential direction D32 as one proceeds toward second axial direction D12) will be referred to as first inclined direction D4. Furthermore, as shown in FIG. 2, the direction D5 which is inclined so as to be increasingly directed toward second circumferential direction D32 as one proceeds toward first axial direction D11 (the direction which is inclined so as to be increasingly directed toward first circumferential direction D31 as one proceeds toward second axial direction D12) will be referred to as second inclined direction D5.

In addition, where it is said that the direction in which something is inclined with respect to tire circumferential direction D3 (tire axial direction D1) is the same as the direction in which something else is inclined with respect thereto, this means that the two are inclined in the same direction with respect thereto (e.g., when the two are mutually in first inclined directions D4, D4 or the two are mutually in second inclined directions D5, D5). That is, where it is said that the direction in which something is inclined with respect to tire circumferential direction D3 (tire axial direction D1) is the same as the direction in which something else is inclined with respect thereto, this should be understood to include the situation in which the two are inclined in the same direction D4, D4 (D5, D5) notwithstanding the fact that the angles of inclination thereof with respect to tire circumferential direction D3 (tire axial direction D1) may be different.

Furthermore, where it is said that the direction in which something is inclined with respect to tire circumferential direction D3 (tire axial direction D1) is opposite the direction in which something else is inclined with respect thereto, this means that the two are inclined in opposite directions (first inclined direction D4 and second inclined direction D5). That is, where it is said that the direction in which something is inclined with respect to tire circumferential direction D3 (tire axial direction D1) is opposite the direction in which something else is inclined with respect thereto, this should be understood to include the situation in which the two are inclined in opposite directions D4, D5 notwithstanding the fact that the angles of inclination thereof with respect to tire circumferential direction D3 (tire axial direction D1) may be the same.

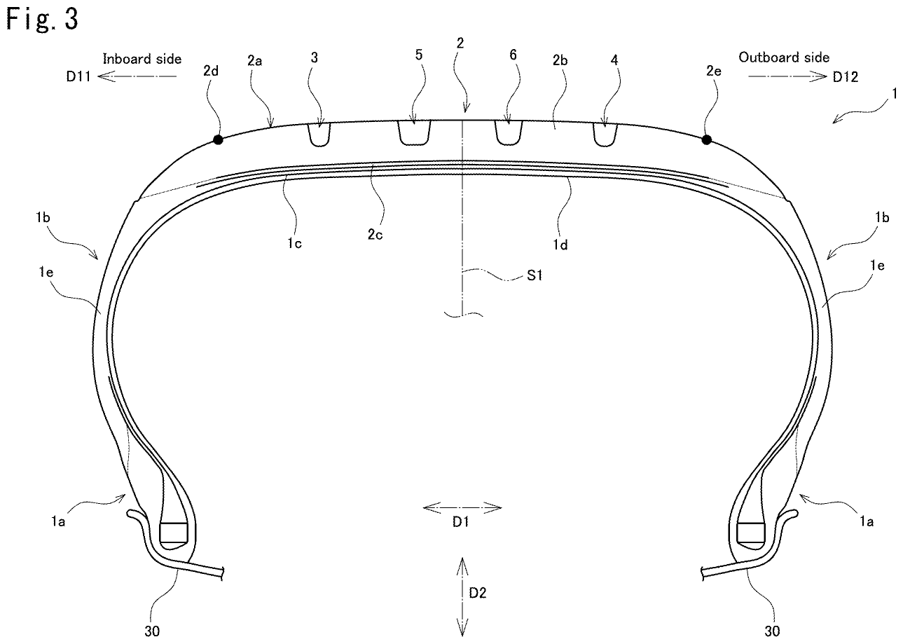

As shown in FIG. 3, tire 1 associated with the present embodiment comprises a pair of beads 1a at which bead cores are present; sidewalls 1b which extend outwardly in the tire radial direction D2 from the respective beads 1a; and tread 2, the exterior surface (tread surface 2a) in the tire radial direction D2 of which contacts the road surface and which is contiguous with the outer ends in the tire radial direction D2 of the pair of sidewalls 1b. In accordance with the present embodiment, tire 1 is a pneumatic tire 1, the interior of which is capable of being filled with air, and which is capable of being mounted on a rim 30.

Furthermore, tire 1 comprises carcass 1c which spans the pair of bead cores, and inner liner 1d which is arranged at a location toward the interior from carcass 1c and which has superior functionality in terms of its ability to impede passage of gas therethrough so as to permit air pressure to be maintained. Carcass 1c and inner liner 1d are arranged in parallel fashion with respect to the inner circumference of the tire over a portion thereof that encompasses beads 1a, sidewalls 1b, and tread 2.

Tire 1 has a structure that is asymmetric with respect to tire equatorial plane S1. In accordance with the present embodiment, tire 1 is a tire for which a vehicle mounting direction is indicated, which is to say that there is an indication of whether the left or the right side of the tire should be made to face the vehicle when tire 1 mounted on rim 30. Moreover, the tread pattern formed at tread surface 2a of tread 2 is shaped in asymmetric fashion with respect to tire equatorial plane S1.

For example, the orientation in which the tire is to be mounted on the vehicle may be indicated at sidewall 1b. More specifically, a constitution may be adopted in which sidewall 1b is provided with sidewall rubber 1e which is arranged toward the exterior in the tire axial direction D1 from carcass 1c so as to constitute the tire exterior surface, said sidewall rubber 1e having at the surface thereof an indicator region (not shown) that indicates an orientation in which the tire is to be mounted on the vehicle.

For example, one sidewall 1b, i.e., that which is to be arranged toward the interior when the tire is mounted on the vehicle (hereinafter also referred to as the “inboard side”), might be marked (e.g., with the word “INSIDE” or the like) so as to contain an indication to the effect that it is for the inboard side. Furthermore, for example, the other sidewall 1b, i.e., that which is to be arranged toward the exterior when the tire is mounted on the vehicle (hereinafter also referred to as the “outboard side”), might be marked (e.g., with the word “OUTSIDE” or the like) so as to contain an indication to the effect that it is for the outboard side. While there is no particular limitation with respect thereto, the side toward first axial direction D11 might, e.g., as is the case in the present embodiment, be taken to be the inboard side, and the side toward second axial direction D12 might be taken to be the outboard side.

Tread 2 is provided with tread rubber 2b having tread surface 2a which contacts the road surface, and belt 2c which is arranged between tread rubber 2b and carcass 1c. In addition, present at tread surface 2a is the contact patch that actually comes in contact with the road surface, the portions within said contact patch that are present at the outer ends in the tire axial direction D1 being referred to as contact patch ends 2d, 2e. Note that said contact patch refers to the tread surface 2a that comes in contact with the road surface when a normal load is applied to a tire 1 mounted on a normal rim 30 when the tire 1 is inflated to normal internal pressure and is placed in vertical orientation on a flat road surface.

Normal load is that load which is specified for use with a particular tire 1 in the context of the body of standards that contains the standard that applies to the tire 1 in question, this being “maximum load capacity” in the case of JATMA, the maximum value listed at the aforementioned table in the case of IRA, or “load capacity” in the case of ETRTO, which when tire 1 is to be used on a passenger vehicle is taken to be 85% of the load corresponding to an internal pressure of 180 kPa.

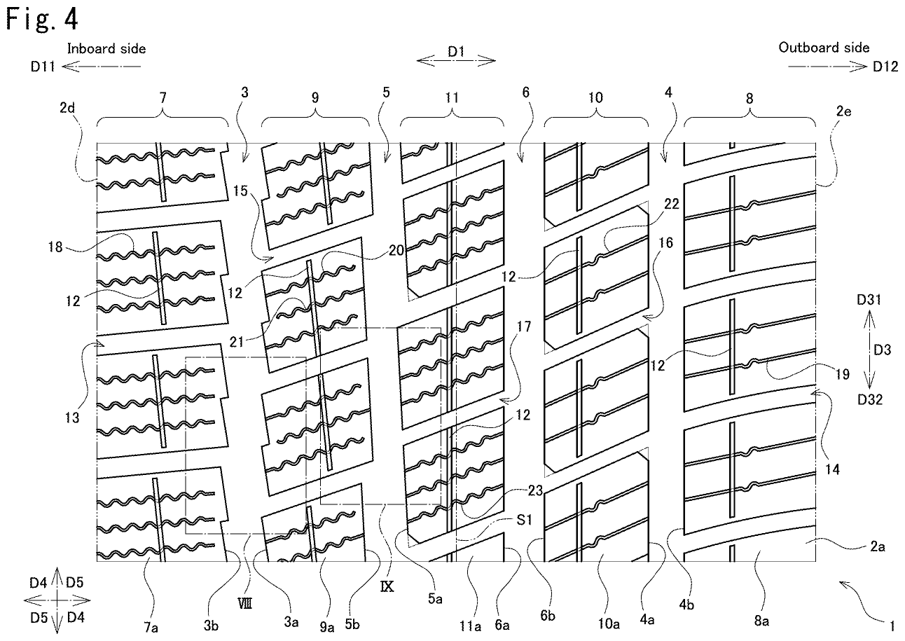

As shown in FIG. 3 and FIG. 4, tread rubber 2b comprises a plurality of main grooves 3, 4, 5, 6 that extend in the tire circumferential direction D3, and a plurality of lands 7, 8, 9, 10, 11 which are partitioned by the plurality of main grooves 3, 4, 5, 6 and a pair of contact patch ends 2d, 2e. While there is no particular limitation with respect thereto, the number of main grooves 3, 4, 5, 6 that are present might, e.g., as is the case in the present embodiment, be four, and the number of lands 7, 8, 9, 10, 11 that are present might be five.

Main grooves 3, 4, 5, 6 extend continuously in the tire circumferential direction D3. Main grooves 3, 4, 5, 6 might, for example, be provided with so-called tread wear indicators (not shown) which are portions at which depth of the groove is reduced so as to make it possible to ascertain the extent to which wear has occurred as a result of the exposure thereof that takes place in accompaniment to wear. Furthermore, main grooves 3, 4, 5, 6 might, for example, have groove widths that are each not less than 3% of the distance (dimension in the tire axial direction D1) between contact patch ends 2d, 2e. Furthermore, main grooves 3, 4, 5, 6 might, for example, have groove widths that are each not less than 5 mm.

The pair of main grooves 3, 4 arranged in outermost fashion in the tire axial direction D1 are referred to as shoulder main grooves 3, 4. Of the shoulder main grooves 3, 4, that main groove 3 which is arranged on the side in the first axial direction D11 (the inboard side) is referred to as first shoulder main groove 3, and that main groove 4 which is arranged on the side in the second axial direction D12 (the outboard side) is referred to as second shoulder main groove 4.

Furthermore, the main grooves 5, 6 arranged between the pair of shoulder main grooves 3, 4 are referred to as center main grooves 5, 6. Of the center main grooves 5, 6, that main groove 5 which is arranged on the side in the first axial direction D11 (the inboard side) is referred to as first center main groove 5, and that main groove 6 which is arranged on the side in the second axial direction D12 (the outboard side) is referred to as second center main groove 6.

Lands 7, 8 which are partitioned by a contact patch end 2d, 2e and a shoulder main groove 3, 4 are referred to as shoulder lands 7, 8; lands 9, 10, 11 which are partitioned by a pair of adjacent main grooves 3, 4, 5, 6 are referred to as middle lands 9, 10, 11. Note that middle lands 9, 10 which are partitioned by a center main groove 5, 6 and a shoulder main groove 3, 4 are also referred to as mediate lands 9, 10; middle land 11 which is partitioned by the pair of center main grooves 5, 6 is also referred to as center land 11.

Of the shoulder lands 7, 8, that land 7 which is arranged on the side in the first axial direction D11 (the inboard side) is referred to as first shoulder land 7, and that land 8 which is arranged on the side in the second axial direction D12 (the outboard side) is referred to as second shoulder land 8. Furthermore, of the mediate lands 9, 10, that land 9 which is arranged on the side in the first axial direction D11 (the inboard side) is referred to as first mediate land 9, and that land 10 which is arranged on the side in the second axial direction D12 (the outboard side) is referred to as second mediate land 10.

While there is no particular limitation with respect thereto, main grooves 3, 4, 5, 6 may, e.g., as is the case in the present embodiment, comprise straight main grooves 4, 6 and zigzag main grooves 3, 5. Note that straight main grooves 4, 6 are main grooves 4, 6 at which end edges 4a, 4b, 6a, 6b at tread surface 2a are respectively parallel to the tire circumferential direction D3; zigzag main grooves 3, 5 are main grooves 3, 5 at which end edges 3a, 3b, 5a, 5b at tread surface 2a are respectively inclined with respect to the tire circumferential direction D3.

Lands 7, 8, 9, 10, 11 comprise a plurality of ancillary grooves 12, 13, . . . , 22, 23. Of ancillary grooves 12, 13, . . . , 22, 23, those ancillary grooves 12 which extend in the tire circumferential direction D3 are referred to as circumferential grooves 12; of ancillary grooves 12, 13, . . . , 22, 23, those ancillary grooves 13, 14, . . . , 22, 23 which extend in the tire axial direction D1 are referred to as axial grooves 13, 14, . . . , 22, 23.

In addition, of axial grooves 13, 14, . . . , 22, 23, those axial grooves 13, 14, 15, 16, 17 for which the groove width at tread surface 2a is not less than 1.6 mm are referred to as slits 13, 14, 15, 16, 17. Furthermore, of axial grooves 13, 14, . . . , 22, 23, those axial grooves 18, 19, . . . , 22, 23 for which the groove width at tread surface 2a is less than 1.6 mm are referred to as sipes 18, 19, . . . , 22, 23.

Note that the angles of inclination of circumferential grooves 12 with respect to the tire circumferential direction D3 are less than 45°, it being preferred, for example, that these be not greater than 30°. Furthermore, the angles of inclination of axial grooves 13, 14, . . . , 22, 23 with respect to tire axial direction D1 are not greater than 45°, it being preferred, for example, that these be not greater than 30°.

While there is no particular limitation with respect thereto, slits 13, 14, 15, 16, 17 may, e.g., as is the case in the present embodiment, all extend along the full length in the tire axial direction D1 of lands 7, 8, 9, 10, 11. That is, each of the two ends of each slit 13, 14, 15, 16, 17 may respectively be contiguous with a main groove 3, 4, 5, 6 or a contact patch end 2d, 2e. As a result, lands 7, 8, 9, 10, 11 comprise a plurality of blocks 7a, 8a, 9a, 10a, 11a which are partitioned by slits 13, 14, 15, 16, 17 so as to as to be arrayed in the tire circumferential direction D3.

While there is no particular limitation with respect thereto, note that the number of blocks 7a, 8a, 9a, 10a, 11a in the respective lands 7, 8, 9, 10, 11 may, e.g., as is the case in the present embodiment, be the same, and/or the number of slits 13, 14, 15, 16, 17 in the respective lands 7, 8, 9, 10, 11 may be the same. Furthermore, while there is no particular limitation with respect thereto, the groove widths of slits 13, 14, 15, 16, 17 may, e.g., as is the case in the present embodiment, be constant (here understood to mean not only the situation in which these are the same but to also include situations in which these are approximately the same such that there is a difference of ±5% therebetween) everywhere along the full lengths thereof.

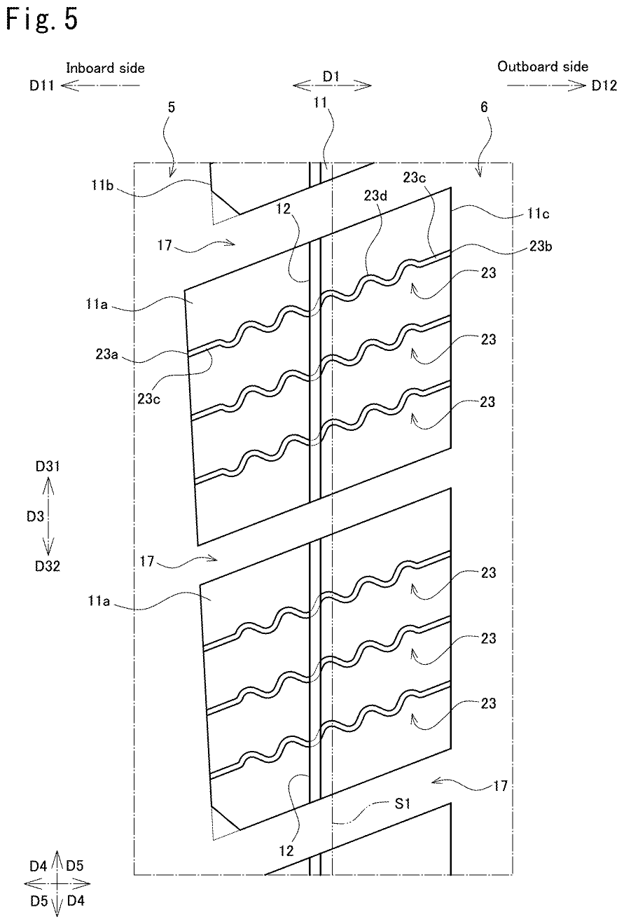

The constitution of center land 11 will now be described with reference to FIG. 5.

For example, when the vehicle is going straight ahead, contact patch length (length in the tire circumferential direction D3) in regions toward the interior in the tire axial direction D1 (particularly, at center land 11) might increase. As a result, many sipes (sometimes referred to as “center sipes”) 23 at center land 11 will come in contact with the ground.

To address this, as shown in FIG. 5, at center land 11, first ends 23a of all sipes 23 are contiguous with first end 11b in the tire axial direction D1 of center land 11, and second ends 23b of all sipes 23 are contiguous with second end 11c in the tire axial direction D1 of center land 11. That is, first end 23a of sipe 23 is contiguous with first center main groove 5, and second end 23b of sipe 23 is contiguous with second center main groove 6.

As a result, because sipes 23 at center land 11 which has large contact patch length will tend to deform so as to become wider, this will make it possible to effectively increase traction attributable to edges of sipes 23 when on a snowy road surface. Accordingly, at center land 11, it will be possible, for example, to effectively improve performance on snowy road surfaces as a result of provision of traction.

Sipe 23 may, for example, comprise straight portion(s) 23c which extend in straight fashion, and zigzag portion(s) 23d which extend in zigzag fashion. A constitution may be adopted in which, e.g., as is the case in the present embodiment, a pair of straight portions 23c are arranged at either end in the tire axial direction D1 of sipe 23, and a zigzag portion 23d is arranged between the pair of straight portions 23c, 23c.

Furthermore, at sipe 23 in center land 11, length of zigzag portion 23d may, e.g., as is the case in the present embodiment, be greater than length of straight portion 23c. Furthermore, sipes 23 and slits (sometimes referred to as “center slits”) 17 of center land 11 may, e.g., as is the case in the present embodiment, be inclined in the same direction (second inclined direction) D5 with respect to the tire axial direction D1.

Note that what are referred to as the lengths of sipes 18, 19, . . . , 22, 23 (and the same is true of the lengths of respective portions 18a, 18b, 20a, 20b, 21a, 21b, 23a, 23b) are the lengths along the midpoints of the groove widths of sipes 18, 19, . . . , 22, 23.

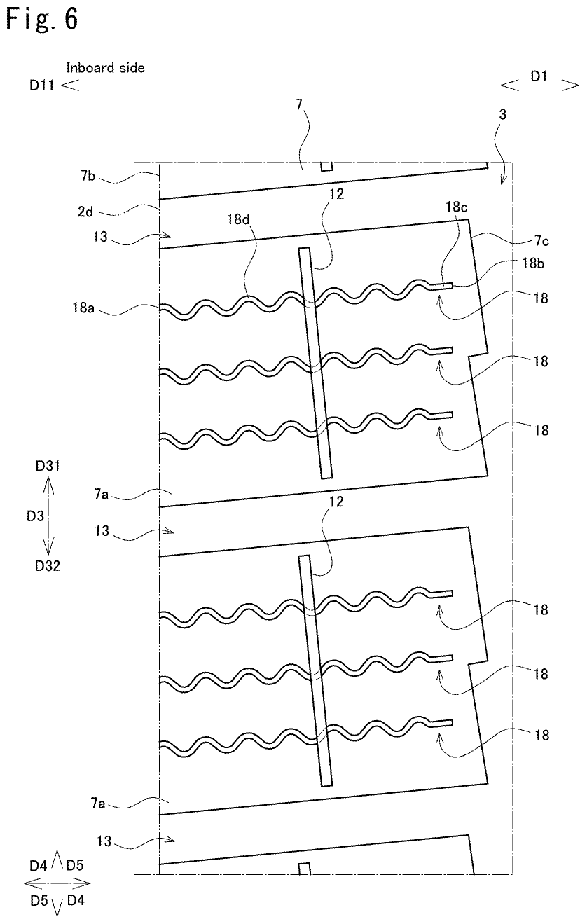

Next, the constitution of first shoulder land 7 will be described with reference to FIG. 6.

As shown in FIG. 6, first ends (outer ends in the tire axial direction D1) 18a of all sipes 18 are contiguous with outer end 7b in the tire axial direction D1 of first shoulder land 7. That is, first end 18a of each sipe 18 is contiguous with first contact patch end 2d. As a result, because it is possible to ensure that sipes 18 will tend to widen, it is possible to suppress occurrence of a situation in which traction attributable to edges of sipes 18 might otherwise be reduced.

Furthermore, because there will be a tendency for the shape of the contact patch to change in a region toward the exterior in the tire axial direction D1, i.e., at first shoulder land 7, in accompaniment to whether the vehicle is going straight ahead, turning, braking, and so forth, there will be a tendency for uneven wear to occur. Second ends (inner ends in the tire axial direction D1) 18b of all sipes 18 are therefore separated from inner end 7c in the tire axial direction D1 of first shoulder land 7. That is, second end 18b of sipe 18 is separated from first shoulder main groove 3.

As a result, because it will be possible to suppress lowering of rigidity at first shoulder land 7, it will be possible to suppress occurrence of uneven wear. Accordingly, at first shoulder land 7, it will be possible, for example, to achieve both performance with respect to resistance to uneven wear as a result of ensuring good rigidity and performance on snowy road surfaces as a result of provision of traction.

Moreover, when the vehicle is driven, the actual locations of the contact patch ends will vary in the tire axial direction D1. When under a heavy load, for example, the actual locations of the contact patch ends will be toward the exterior in the tire axial direction D1 from first and second contact patch ends 2d, 2e; when under a light load, for example, the actual locations of the contact patch ends will be toward the interior in the tire axial direction D1 from first and second contact patch ends 2d, 2e.

To address this, sipe 18 is separated not from outer end 7b of first shoulder land 7 but from inner end 7c of first shoulder land 7. As a result, even in situations in which the actual locations of the contact patch ends vary in the tire axial direction D1, it will be possible to cause second ends 18b of sipe 18 to be definitively separated from inner end 7c of first shoulder land 7. Accordingly, it will be possible to definitively suppress lowering of rigidity at first shoulder land 7.

Sipe 18 may, for example, comprise straight portion(s) 18c which extend in straight fashion, and zigzag portion(s) 18d which extend in zigzag fashion. A constitution may be adopted in which, e.g., as is the case in the present embodiment, straight portion(s) 18c are arranged toward the interior in the tire axial direction D1 of sipe 18, and zigzag portion(s) 18d are arranged toward the exterior in the tire axial direction D1 of sipe 18.

Furthermore, at sipe 18 in first shoulder land 7, length of zigzag portion 18d may, e.g., as is the case in the present embodiment, be greater than length of straight portion 18c. Furthermore, sipes 18 and slits 13 of first shoulder land 7 may, e.g., as is the case in the present embodiment, be inclined in the same direction (second inclined direction) D5 with respect to the tire axial direction D1.

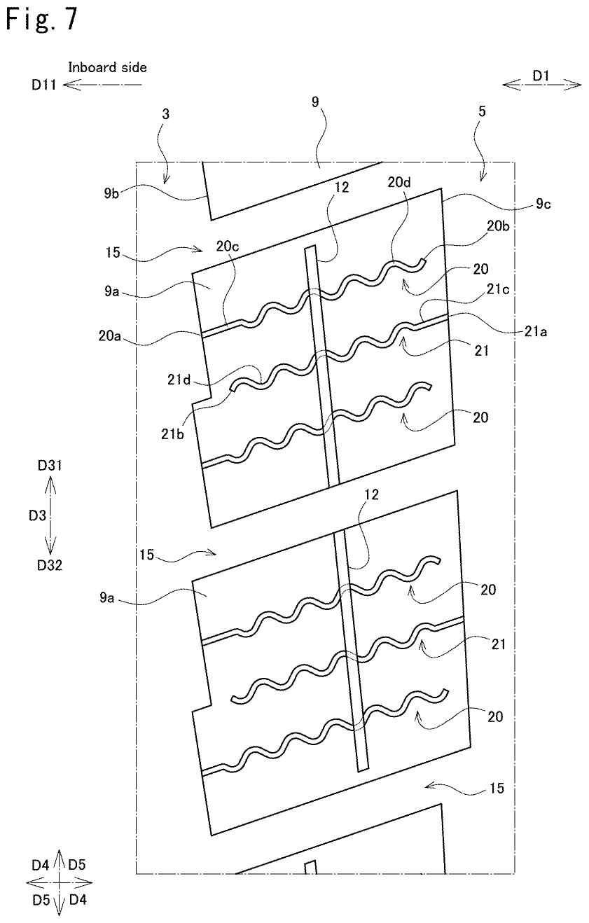

Next, the constitution of first mediate land 9 will be described with reference to FIG. 7.

As shown in FIG. 7, at first mediate land 9, first ends 20a, 21a of all sipes 20, 21 are contiguous with side end 9b, 9c in the tire axial direction D1 of first mediate land 9. That is, first end 20a, 21a of each sipe 20, 21 is contiguous with main groove 3, 5. This makes it possible to ensure that sipes 20, 21 will tend to widen.

On the other hand, second ends 20b, 21b of all sipes 20, 21 are separated from side end 9c, 9b in the tire axial direction D1 of first mediate land 9. That is, second end 20b, 21b of each sipe 20, 21 is separated from main groove 5, 3. As a result, this makes it possible to suppress reduction in rigidity at first mediate land 9. Thus, at first mediate land 9, it will be possible, for example, to achieve both performance with respect to resistance to uneven wear as a result of ensuring good rigidity and performance on snowy road surfaces as a result of provision of traction.

Furthermore, outer end 9b of first mediate land 9 is contiguous with first sipe (sometimes referred to as “first mediate sipe”) 20 but is separated from second sipe (sometimes referred to as “second mediate sipe”) 21, and inner end 9c of first mediate land 9 is contiguous with second sipe 21 but is separated from first sipe 20. As a result, at first mediate land 9, it will be possible to suppress occurrence of differences in rigidity in the tire axial direction D1.

Moreover, first sipe 20 and second sipe 21 are adjacent in the tire circumferential direction D3. More specifically, two first sipes 20, 20 straddle second sipe 21 in the tire circumferential direction D3. As a result, at first mediate land 9, it will be possible to effectively suppress occurrence of differences in rigidity in the tire axial direction D1. Accordingly, it is possible to further improve wear-resistance, for example.

Moreover, whereas first end 23a and second end 23b of center sipe 23 are contiguous with side ends 11b, 11c of center land 11 (see FIG. 5), only first end 18a of shoulder sipe 18 is contiguous with side end 7b of first shoulder land 7 (see FIG. 6), and so the rigidity of center land 11 tends to be lower than the rigidity of first shoulder land 7. To address this, the number of second sipes 21 is less than the number of first sipes 20.

As a result, it will be possible suppress lowering of rigidity in a region toward the interior in the tire axial direction D1 of first mediate land 9, i.e., in a region toward center land 11. Accordingly, because it will be possible to achieve well-balanced rigidity at center land 11, first mediate land 9, and first shoulder land 7, for example, this will make it possible, for example, to improve performance with respect to resistance to uneven wear.

Sipes 20, 21 may, for example, comprise straight portion(s) 20c, 21c which extend in straight fashion, and zigzag portion(s) 20d, 21d which extend in zigzag fashion. In addition, straight portions 20c, 21c may be contiguous with side ends 9b, 9c of first mediate land 9, and zigzag portions 20d, 21d may be separated from side ends 9c, 9b of first mediate land 9.

A constitution may be adopted in which, e.g., as is the case in the present embodiment, at first sipe 20, straight portion 20c is arranged toward the exterior in the tire axial direction D1 of sipe 20, and zigzag portion 20d is arranged toward the interior in the tire axial direction D1 of sipe 20. Furthermore, a constitution may be adopted in which, e.g., as is the case in the present embodiment, at second sipe 21, straight portion 21c is arranged toward the interior in the tire axial direction D1 of sipe 21, and zigzag portion 21d is arranged toward the exterior in the tire axial direction D1 of sipe 21.

Furthermore, at sipes 20, 21 in first mediate land 9, lengths of zigzag portions 20d, 21d may, e.g., as is the case in the present embodiment, be greater than lengths of straight portions 20c, 21c. Furthermore, sipes 20, 21 and slits (also referred to as “mediate slits”) 15 of first mediate land 9 may, e.g., as is the case in the present embodiment, be inclined in the same direction (second inclined direction) D5 with respect to the tire axial direction D1.

Moreover as shown in FIG. 5 through FIG. 7, slits 13, 15, 17 of respective lands 7, 9, 11 may, e.g., as is the case in the present embodiment, be inclined in the same direction (second inclined direction) D5 with respect to the tire axial direction D1. Furthermore, sipes 18, 20, 21, 23 of respective lands 7, 9, 11 may, e.g., as is the case in the present embodiment, be inclined in the same direction (second inclined direction) D5 with respect to the tire axial direction D1.

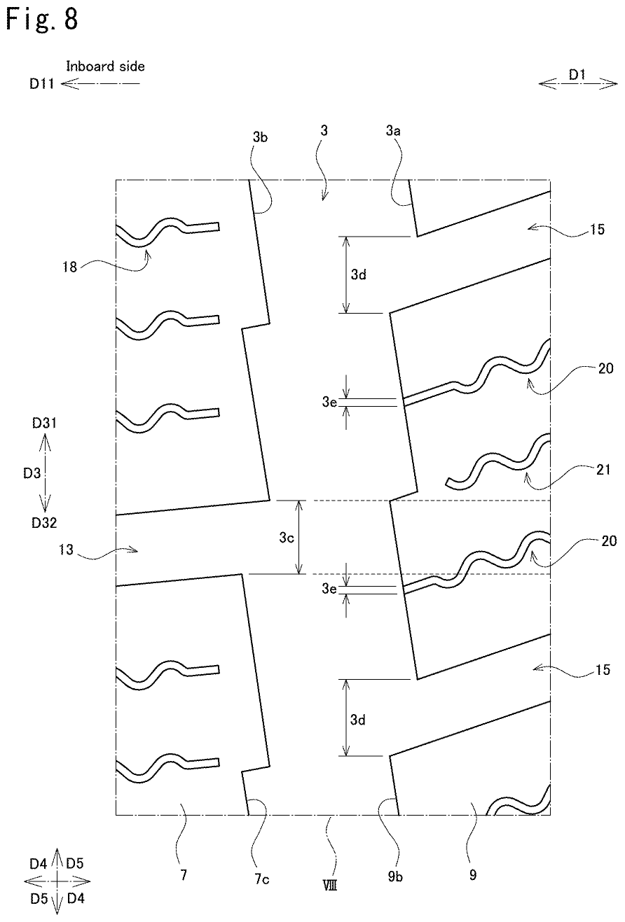

Next, the constitution with respect to first shoulder main groove 3, first shoulder land 7, and first mediate land 9 will be described with reference to FIG. 8.

As shown in FIG. 8, first shoulder main groove 3 comprises first opening 3c which is contiguous with shoulder slit 13 at end edge 3b toward the exterior in the tire axial direction D1. Furthermore, first shoulder main groove 3 comprises second opening 3d which is contiguous with mediate slit 15 at end edge 3a toward the interior in the tire axial direction D1, and third opening 3e which is contiguous with first mediate sipe 20.

It so happens that when tire 1 rolls and shoulder slit 13 is located at an end in the tire circumferential direction D3 of the contact patch, there is a tendency for a large force to act at a region adjacent in the tire axial direction D1 to shoulder slit 13. That is, there is a tendency for a large force to act at that portion of the region toward the exterior in the tire axial direction D1 at first mediate land 9 which is at the same location in the tire circumferential direction D3 as shoulder slit 13 (shown in dashed line at FIG. 8).

Because the rigidity of regions at first mediate land 9 which correspond to second opening 3d and third opening 3e will be reduced, first opening 3c is therefore separated in the tire circumferential direction D3 from second opening 3d and third opening 3e. As a result, that portion of the region at the exterior of first mediate land 9 at which rigidity is low is separated in the tire circumferential direction D3 from first opening 3c.

Accordingly, when shoulder slit 13 is located at an end in the tire circumferential direction D3 of the contact patch, it is possible to suppress occurrence of a situation in which a force would otherwise act at that portion of the region at the exterior of first mediate land 9 at which rigidity is low. As a result, it will be possible to suppress occurrence of uneven wear in a region at the exterior of first mediate land 9. At FIG. 8, note that the extents in the tire circumferential direction D3 of respective openings 3c, 3d, 3e are the extents indicated by the arrows.

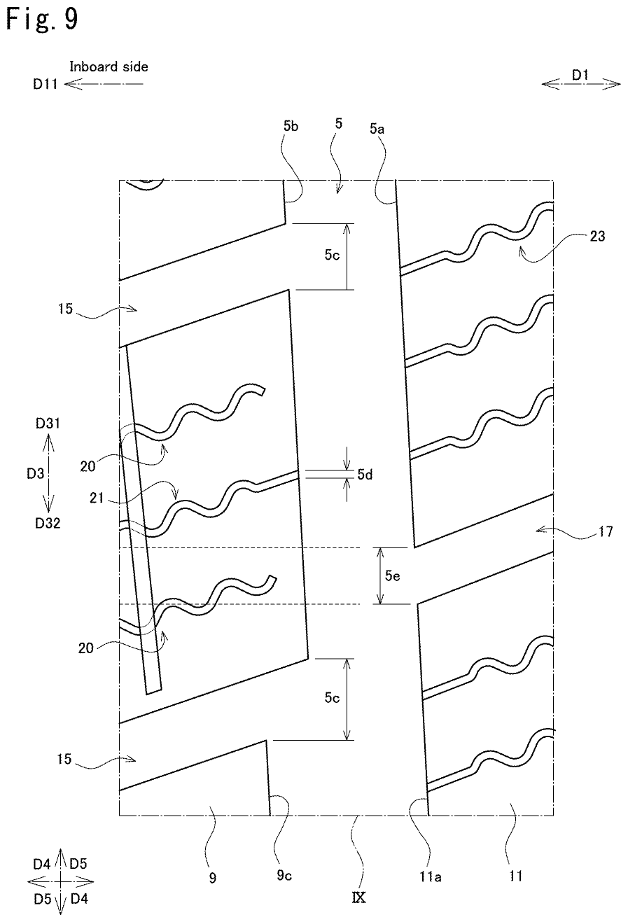

Next, the constitution with respect to first center main groove 5, first mediate land 9, and center land 11 will be described with reference to FIG. 9.

As shown in FIG. 9, first center main groove 5 comprises fourth opening 5c which is contiguous with mediate slit 15 and fifth opening 5d which is contiguous with second mediate sipe 21, at end edge 5b toward the exterior in the tire axial direction D1. Furthermore, first center main groove 5 comprises sixth opening 5e which is contiguous with center slit 17 at end edge 5a toward the interior in the tire axial direction D1.

It so happens that when tire 1 rolls and center slit 17 is located at an end in the tire circumferential direction D3 of the contact patch, there is a tendency for a large force to act at a region adjacent in the tire axial direction D1 to center slit 17. That is, there is a tendency for a large force to act at that portion of the region toward the interior in the tire axial direction D1 at first mediate land 9 which is at the same location in the tire circumferential direction D3 as center slit 17 (shown in dashed line at FIG. 9).

Because the rigidity of regions at first mediate land 9 which correspond to fourth opening 5c and fifth opening 5d will be reduced, sixth opening 5e is therefore separated in the tire circumferential direction D3 from fourth opening 5c and fifth opening 5d. As a result, that portion of the region at the interior of first mediate land 9 at which rigidity is low is separated in the tire circumferential direction D3 from sixth opening 5e.

Accordingly, when center slit 17 is located at an end in the tire circumferential direction D3 of the contact patch, it is possible to suppress occurrence of a situation in which a force would otherwise act at that portion of the region at the interior of first mediate land 9 at which rigidity is low. As a result, it will be possible to suppress occurrence of uneven wear in a region at the interior of first mediate land 9. At FIG. 9, note that the extents in the tire circumferential direction D3 of respective openings 5c, 5d, 5e are the extents indicated by the arrows.

As described above, as in the present embodiment, it is preferred that

the pneumatic tire 1 includes a plurality of main grooves 3, 4, 5, 6 extending in a tire circumferential direction D3, and a plurality of lands 7, 8, 9, 10, 11 which are partitioned by the plurality of main grooves 3, 4, 5, 6 and first and second contact patch ends 2d, 2e, wherein:

the plurality of lands 7, 8, 9, 10, 11 include a shoulder land 7 (first shoulder land 7 in the present embodiment) which is arranged so as to be outwardmost in a tire axial direction D1, and a first middle land 9 (first mediate land 9 in the present embodiment) which is adjacent to the shoulder land 7;

the shoulder land 7 comprises a plurality of shoulder slits 13 which each extend across a full width of the shoulder land 7 in the tire axial direction D1, and a plurality of shoulder blocks 7a which are partitioned by the plurality of shoulder slits 13;

the first middle land 9 comprises a plurality of first middle slits 15 (mediate slits 15 in the present embodiment) which each extend across a full width of the first middle land 9 in the tire axial direction D1, and a plurality of first middle blocks 9a which are partitioned by the plurality of first middle slits 15;

a number of the shoulder blocks 7a is equal to a number of the first middle blocks 9a;

the plurality of main grooves 3, 4, 5, 6 include a shoulder main groove 3 (first shoulder main groove 3 in the present embodiment) which is arranged between the shoulder land 7 and the first middle land 9;

the first middle land 9 comprises a plurality of first middle sipes 20 (first mediate sipes 20 in the present embodiment) which are contiguous with the shoulder main groove 3;

the shoulder main groove 3 comprises a plurality of first openings 3c which are contiguous with the plurality of shoulder slits 13, a plurality of second openings 3d which are contiguous with the plurality of first middle slits 15, and a plurality of third openings 3e which are contiguous with the plurality of first middle sipes 20; and

the plurality of first openings 3c are respectively separated in the tire circumferential direction D3 from all of the second openings 3d and all of the third openings 3e.

In accordance with such constitution, because first middle sipe 20 is contiguous with shoulder main groove 3, it is possible to ensure that first middle sipe 20 will tend to widen. In addition, when tire 1 rolls and shoulder slit 13 is located at an end in the tire circumferential direction D3 of the contact patch, there is a tendency for a large force to act at that portion of the region toward the exterior in the tire axial direction D1 at first middle land 9 which is at the same location in the tire circumferential direction D3 as shoulder slit 13.

First opening 3c is therefore separated in the tire circumferential direction D3 from second opening 3d and third opening 3e. As a result, that portion of the region at the exterior of first middle land 9 at which rigidity is low is separated in the tire circumferential direction D3 from first opening 3c.

Accordingly, because when shoulder slit 13 is located at an end in the tire circumferential direction D3 of the contact patch, it is possible to suppress occurrence of a situation in which a force would otherwise act at that portion of the region at the exterior of first middle land 9 at which rigidity is low, it is possible to suppress occurrence of uneven wear in a region at the exterior of first middle land 9. As a result, it will be possible to improve performance with respect to resistance to uneven wear while ensuring good performance on snowy road surfaces.

Further, as in the present embodiment, it is preferred that the pneumatic tire 1 includes a configuration in which:

the shoulder land 7 (first shoulder land 7 in the present embodiment) comprises a plurality of shoulder sipes 18; and

all of the shoulder sipes 18 are contiguous with the first contact patch end 2d but are separated from the shoulder main groove 3 (first shoulder main groove 3 in the present embodiment).

In accordance with such constitution, because shoulder sipe 18 is contiguous with first contact patch end 2d, it is possible to ensure that shoulder sipe 18 will tend to widen. Moreover, because shoulder sipe 18 is separated from shoulder main groove 3, it will be possible to suppress reduction in rigidity of shoulder land 7. This will make it possible to suppress occurrence of uneven wear at shoulder land 7.

Further, as in the present embodiment, it is preferred that the pneumatic tire 1 includes a configuration in which:

the plurality of lands 7, 8, 9, 10, 11 further comprise a second middle land 11 (center land 11 in the present embodiment)which is adjacent to the first middle land 9 (first mediate land 9 in the present embodiment);

the second middle land 11 comprises a plurality of second middle slits 17 (center slits 17 in the present embodiment) which each extend across a full width of the second middle land 11 in the tire axial direction D1, and a plurality of second middle blocks 11a which are partitioned by the plurality of second middle slits 17;

a number of the second middle blocks 11a is equal to a number of the first middle blocks 9a;

the plurality of main grooves 3, 4, 5, 6 further include a center main groove 5 (first center main groove 5 in the present embodiment) which is arranged between the first middle land 9 and the second middle land 11;

the first middle land 9 further comprises a plurality of second middle sipes 21 (second mediate sipes 21 in the present embodiment)which are contiguous with the center main groove 5;

the center main groove 5 comprises a plurality of fourth openings 5c which are contiguous with the plurality of first middle slits 15 (mediate slits 15 in the present embodiment), a plurality of fifth openings 5d which are contiguous with the plurality of second middle sipes 21, and a plurality of sixth openings 5e which are contiguous with the plurality of second middle slits 17; and

the plurality of sixth openings 5e are respectively separated in the tire circumferential direction from all of the fourth openings 5c and all of the fifth openings 5d.

In accordance with such constitution, because second middle sipe 21 is contiguous with center main groove 5, it will be possible to ensure that second middle sipe 21 will tend to widen. In addition, when tire 1 rolls and second middle slit 17 is located at an end in the tire circumferential direction D3 of the contact patch, there is a tendency for a large force to act at that portion of the region toward the interior in the tire axial direction D1 at first middle land 9 which is at the same location in the tire circumferential direction D3 as second middle slit 17.

Sixth opening 5e is therefore separated in the tire circumferential direction D3 from fourth opening 5c and fifth opening 5d. As a result, that portion of the region at the interior of first middle land 9 at which rigidity is low is separated in the tire circumferential direction D3 from sixth opening 5e. Accordingly, because when second middle slit 17 is located at an end in the tire circumferential direction D3 of the contact patch, it is possible to suppress occurrence of a situation in which a force would otherwise act at that portion of the region at the interior of first middle land 9 at which rigidity is low, it is possible to suppress occurrence of uneven wear in a region at the interior of first middle land 9.

Further, as in the present embodiment, it is preferred that the pneumatic tire 1 includes a configuration in which:

the plurality of first middle sipes 20 (first mediate sipes 20 in the present embodiment) are separated from the center main groove 5 (first center main groove 5 in the present embodiment); and

the plurality of second middle sipes 21 (second mediate sipes 21 in the present embodiment) are separated from the shoulder main groove 3 (first shoulder main groove 3 in the present embodiment).

In accordance with such constitution, because first and second middle sipes 20, 21 are contiguous with one set of main grooves 3, 5, this makes it possible to ensure that first and second middle sipes 20, 21 will tend to widen. Moreover, because first and second middle sipes 20, 21 are separated from the other set of main grooves 5, 3, it will be possible to suppress reduction in rigidity at first middle land 9.

Moreover, outer end 9b in the tire axial direction D1 of first middle land 9 is contiguous with first middle sipe 20 but is separated from second middle sipe 21, and inner end 9c in the tire axial direction D1 of first middle land 9 is contiguous with second middle sipe 21 but is separated from first middle sipe 20. As a result, at first middle land 9, it will be possible to suppress occurrence of differences in rigidity in the tire axial direction D1.

Further, as in the present embodiment, it is preferred that the pneumatic tire 1 includes a configuration in which:

at least one of the second middle sipes 21 (second mediate sipes 21 in the present embodiment) is straddled in the tire circumferential direction D3 by two first middle sipes 20, 20 which, among the plurality of first middle sipes (first mediate sipes 20 in the present embodiment), are adjacent thereto in the tire circumferential direction D3.

In accordance with such constitution, first middle sipe 20 and second middle sipe 21 are adjacent in the tire circumferential direction D3. As a result, at first middle land 9, it will be possible to effectively suppress occurrence of differences in rigidity in the tire axial direction D1.

The pneumatic tire 1 is not limited to the configuration of the embodiment described above, and the effects are not limited to those described above. It goes without saying that the pneumatic tire 1 can be variously modified without departing from the scope of the subject matter of the present invention. For example, the constituents, methods, and the like of various modified examples described below may be arbitrarily selected and employed as the constituents, methods, and the like of the embodiments described above, as a matter of course.

(1) The constitution of pneumatic tire 1 associated with the foregoing embodiment is such that all shoulder sipes 18 are contiguous with first contact patch end 2d but are separated from first shoulder main groove 3. However, pneumatic tire 1 is not limited to such constitution. For example, it is also possible to adopt a constitution in which at least one shoulder sipe 18 is separated from first contact patch end 2d. Furthermore, for example, it is also possible to adopt a constitution in which at least one shoulder sipe 18 is contiguous with first shoulder main groove 3.

(2) Furthermore, the constitution of pneumatic tire 1 associated with the foregoing embodiment is such that a plurality of sixth openings 5e are respectively separated in the tire circumferential direction D3 from all fourth openings 5c and all fifth openings 5d. However, pneumatic tire 1 is not limited to such constitution. For example, it is also possible to adopt a constitution in which at least one sixth opening 5e is partially arranged at the same location(s) in the tire circumferential direction D3 as at least one fourth opening 5c and/or fifth opening 5d.

(3) Furthermore, the constitution of pneumatic tire 1 associated with the foregoing embodiment is such that first middle sipe (first mediate sipe) 20 is contiguous with first shoulder main groove 3 but is separated from first center main groove 5. However, pneumatic tire 1 is not limited to such constitution. For example, it is also possible to adopt a constitution in which first middle sipe (first mediate sipe) 20 is respectively contiguous with first shoulder main groove 3 and first center main groove 5.

(4) Furthermore, the constitution of pneumatic tire 1 associated with the foregoing embodiment is such that second middle sipe (second mediate sipe) 21 is contiguous with first center main groove 5 but is separated from first shoulder main groove 3. However, pneumatic tire 1 is not limited to such constitution. For example, it is also possible to adopt a constitution in which second middle sipe (second mediate sipe) 21 is respectively contiguous with first shoulder main groove 3 and first center main groove 5.

(5) Furthermore, the constitution of pneumatic tire 1 associated with the foregoing embodiment is such that the two middle sipes (mediate sipes) 20, 20 adjacent to either side in the tire circumferential direction D3 to second middle sipe (second mediate sipe) 21 are respectively first middle sipes (first mediate sipes) 20. However, pneumatic tire 1 is not limited to such constitution. For example, it is also possible to adopt a constitution in which second middle sipes (second mediate sipes) 21, 21 are mutually adjacent in the tire circumferential direction D3.

(6) Furthermore, the constitution of pneumatic tire 1 associated with the foregoing embodiment is such that this is a tire for which a vehicle mounting direction is indicated. However, pneumatic tire 1 is not limited to such constitution. For example, it is also possible to adopt a constitution in which pneumatic tire 1 is a tire for which a vehicle mounting direction is not indicated. More specifically, the tread pattern may be a tread pattern that exhibits point symmetry about an arbitrary point on the tire equator, or may be a tread pattern that exhibits line symmetry about the tire equator.

1. A pneumatic tire comprising a plurality of main grooves extending in a tire circumferential direction, and a plurality of lands which are partitioned by the plurality of main grooves and first and second contact patch ends, wherein:
the plurality of lands include a shoulder land which is arranged so as to be outwardmost in a tire axial direction, and a first middle land which is adjacent to the shoulder land;
the shoulder land comprises a plurality of shoulder slits which each extend across a full width of the shoulder land in the tire axial direction, and a plurality of shoulder blocks which are partitioned by the plurality of shoulder slits;
the first middle land comprises a plurality of first middle slits which each extend across a full width of the first middle land in the tire axial direction, and a plurality of first middle blocks which are partitioned by the plurality of first middle slits;
a number of the shoulder blocks is equal to a number of the first middle blocks;
the plurality of main grooves include a shoulder main groove which is arranged between the shoulder land and the first middle land;
the first middle land comprises a plurality of first middle sipes which are contiguous with the shoulder main groove;
the shoulder main groove comprises a plurality of first openings which are contiguous with the plurality of shoulder slits, a plurality of second openings which are contiguous with the plurality of first middle slits, and a plurality of third openings which are contiguous with the plurality of first middle sipes; and
the plurality of first openings are respectively separated in the tire circumferential direction from all of the second openings and all of the third openings.

2. The pneumatic tire according to claim 1 wherein
the shoulder land comprises a plurality of shoulder sipes; and
all of the shoulder sipes are contiguous with the first contact patch end but are separated from the shoulder main groove.

3. The pneumatic tire according to claim 1 wherein
the plurality of lands further comprise a second middle land which is adjacent to the first middle land;
the second middle land comprises a plurality of second middle slits which each extend across a full width of the second middle land in the tire axial direction, and a plurality of second middle blocks which are partitioned by the plurality of second middle slits;
a number of the second middle blocks is equal to a number of the first middle blocks;
the plurality of main grooves further include a center main groove which is arranged between the first middle land and the second middle land;
the first middle land further comprises a plurality of second middle sipes which are contiguous with the center main groove;
the center main groove comprises a plurality of fourth openings which are contiguous with the plurality of first middle slits, a plurality of fifth openings which are contiguous with the plurality of second middle sipes, and a plurality of sixth openings which are contiguous with the plurality of second middle slits; and
the plurality of sixth openings are respectively separated in the tire circumferential direction from all of the fourth openings and all of the fifth openings.

4. The pneumatic tire according to claim 3 wherein
the plurality of first middle sipes are separated from the center main groove; and
the plurality of second middle sipes are separated from the shoulder main groove.

5. The pneumatic tire according to claim 4 wherein at least one of the second middle sipes is straddled in the tire circumferential direction by two first middle sipes which, among the plurality of first middle sipes, are adjacent thereto in the tire circumferential direction.

6. The pneumatic tire according to claim 4 wherein a number of the first middle sipes is greater than a number of the second middle sipes.

7. The pneumatic tire according to claim 1 wherein at least one of the first middle sipes comprises at least one first straight portion which extends in straight fashion, and at least one first zigzag portion which extends in zigzag fashion.

8. The pneumatic tire according to claim 7 wherein the at least one first straight portion is contiguous with the shoulder main groove.

9. The pneumatic tire according to claim 8 wherein total length of the at least one first zigzag portion is greater than total length of the at least one first straight portion.

10. The pneumatic tire according to claim 1 wherein at least one of the shoulder sipes comprises at least one second straight portion which extends in straight fashion, and at least one second zigzag portion which extends in zigzag fashion.

11. The pneumatic tire according to claim 10 wherein the at least one second zigzag portion is contiguous with the first contact patch end.

12. The pneumatic tire according to claim 11 wherein total length of the at least one second zigzag portion is greater than total length of the at least one second straight portion.

13. The pneumatic tire according to claim 3 wherein at least one of the second middle sipes comprises at least one third straight portion which extends in straight fashion, and at least one third zigzag portion which extends in zigzag fashion.

14. The pneumatic tire according to claim 13 wherein the at least one third straight portion is contiguous with the center main groove.

15. The pneumatic tire according to claim 14 wherein total length of the at least one third zigzag portion is greater than total length of the at least one third straight portion.

16. The pneumatic tire according to claim 3 wherein the second middle land comprises a plurality of third middle sipes which are contiguous with the center main groove.

17. The pneumatic tire according to claim 16 wherein at least one of the third middle sipes comprises at least one fourth straight portion which extends in straight fashion, and at least one fourth zigzag portion which extends in zigzag fashion.

18. The pneumatic tire according to claim 17 wherein the at least one fourth straight portion is contiguous with the center main groove.

19. The pneumatic tire according to claim 18 wherein total length of the at least one fourth zigzag portion is greater than total length of the at least one fourth straight portion.

20. The pneumatic tire according to claim 19 wherein the at least one fourth straight portion comprises a fourth inner straight portion and a fourth outer straight portion;
the at least one fourth zigzag portion comprises a fourth middle zigzag portion; and
the fourth inner straight portion and the fourth outer straight portion are arranged so as to straddle the fourth middle zigzag portion in the tire axial direction.
